(19) United States
(12) Patent Application Publication
(10) Pub. No.: US 2025/0264651 A1
(43) Pub. Date: Aug. 21, 2025

(54) SINGLE ELEMENT PHASE CHANGE OPTICAL STRUCTURE CONTAINING TELLURIUM AND USE THEREOF

(71) Applicant: Gwangju Institute of Science and Technology, Gwangju (KR)

(72) Inventors: Hyeon-Ho JEONG, Gwangju (KR); Young Min SONG, Gwangju (KR); Hyun Min KIM, Gwangju (KR); Jang-Hwan HAN, Gwangju (KR); Gyurin KIM, Gwangju (KR); Juhwan KIM, Gwangju (KR); Joo Hwan KO, Gwangju (KR)

(21) Appl. No.: 19/038,115

(22) Filed: Jan. 27, 2025

(30) Foreign Application Priority Data
Feb. 19, 2024 (KR) 10-2024-0023753

(51) Int. Cl. G02B 5/30

(52) U.S. Cl. CPC G02B 5/3083

(57) ABSTRACT

An embodiment relates to a single element phase change optical structure containing tellurium and a use thereof, and the structure is capable of overcoming a problem of defects of compound-based materials, improving durability, and maximizing optical modulation properties as well by replacing an existing compound-based optical phase change material with a tellurium (Te) single element. The embodiment is capable of maximizing an active color modulation effect by simultaneously using properties of thickness change and phase change of the tellurium (Te), and is also capable of achieving different optical properties by including various shapes of tellurium nanostructures.

### CROSS-REFERENCE TO RELATED APPLICATIONS

This application claims priority from Korean Patent Application No. 10-2024-0023753, filed on Feb. 19, 2024, in the Korean Intellectual Property Office, which is incorporated herein by reference in its entirety.

### TECHNICAL FIELD

The present disclosure relates to a single element phase change optical structure containing tellurium and a use thereof.

### BACKGROUND ART

Optical elements such as lenses, mirrors and prisms are used in various ways as a means to change a path of light within an optical system. Such optical elements are generally made of materials having a fixed refractive index value, and change a path of light by processing the shape. Accordingly, a very complex structure is required in order to control a light path in a desired way within an optical system.

As a way to solve such complexity, there is a method of using a spatial light modulator (SLM) capable of manifoldly performing functions of an optical element. The key to such an SLM function is that the refractive index needs to be controlled in accordance with an external signal. A general SLM performs this function using a liquid crystal, however, there are problems in that the operation speed is slow and the size is limited.

Meanwhile, a phase change material refers to a phase change substance in which a phase of a substance varies depending on changes in the temperature, and refers to a material that exhibits a property that a dielectric constant of a substance changes depending on changes in the external temperature and a refractive index varies accordingly.

Representative examples of a phase change material include vanadium dioxide (VO₂), which has a property of undergoing a rapid phase change at a temperature of about 67° C. (340 K). Specifically, when a phase change occurs at the critical temperature as a boundary, a monoclinic structure having semiconductor properties as a crystal structure in a cold phase is transformed into a tetragonal structure having metal properties in a hot phase. Accordingly, the relative dielectric constant changes from about 8.4 to 5.3, and when the relative dielectric constant is converted into a refractive index, the value changes from a refractive index of about 2.9 to a refractive index of about 2.3. A refractive index of a medium is a factor directly affecting a path of light passing therethrough, and such a transition in the refractive index is reported to occur for a time shorter than 500 fs, and a phase change substance having such properties is known to be applied in active optical elements capable of diversely modulating properties of incident light at a fast reaction speed.

Meanwhile, due to its unique phase change properties, such a phase change material may be widely used in electrical and optical switching devices, sunlight control materials, optical disk dielectric materials, coatings, thermistors and other fields of active optical elements.

Accordingly, development of a phase change material capable of exhibiting excellent optical properties capable of replacing optical structures used in existing active optical elements has been required.

### PRIOR ART DOCUMENTS

### Patent Documents

(Patent Document 1) KR 10-2501643 B1

### DISCLOSURE

### Technical Problem

The present disclosure is directed to providing a single element phase change optical structure containing tellurium and a use thereof.

The present disclosure is also directed to providing a single element phase change optical structure containing tellurium capable of overcoming a problem of defects of compound-based materials, improving durability, and maximizing light modulation properties as well by replacing an existing compound-based optical phase change material with a tellurium (Te) single element, and an active optical element including the same.

The present disclosure is also directed to providing an active thin film resonator capable of maximizing an active color modulation effect by simultaneously using properties of thickness change and phase change of the tellurium (Te).

The present disclosure is also directed to providing an active plasmonic nanostructure capable of achieving different optical properties by including various shapes of tellurium nanostructures.

### Technical Solution

In view of the above, a single element phase change optical structure according to one embodiment of the present disclosure includes a base layer 100; an optical phase change layer 200 formed on an upper surface of the base layer 100; and a protective layer 300 formed on an upper surface of the optical phase change layer 200, wherein the optical phase change layer 200 contains tellurium (Te).

The single element phase change optical structure has excellent light modulation properties due to a phase change of the tellurium (Te).

The single element phase change optical structure has a maximum refractive index variance (Δnₘₐₓᵢₘᵤₘ) of 1.0 to 1.5 at a wavelength of 700 nm when heated from room temperature (R.T) to 100° C.

The single element phase change optical structure has a maximum extinction coefficient variance (Δkₘₐₓᵢₘᵤₘ) of 1.5 to 2.0 at a wavelength of 700 nm when heated from room temperature (R.T) to 100° C.

The optical phase change layer 200 is deposited on the upper surface of the base layer 100 using a thermal evaporation method.

The optical phase change layer may have a deposition temperature (K) range of 150 K to 300 K.

The optical phase change layer 200 has a thickness of 1 nm to 60 nm.

The base layer 100 is a Si substrate layer or a metal mirror layer.

The tellurium (Te) is formed in a structure selected from the group consisting of a thin film, a sphere, a rod, a helix and mixtures thereof.

The sphere has a radius of 40 nm to 60 nm.

The rod has a diameter to height ratio (aspect ratio) of 1:3 to 1:6.

The helix has a minor diameter of 35 nm to 45 nm, and a major diameter of 70 nm to 90 nm.

The helix has a height of 100 nm to 150 nm.

The protective layer 300 is selected from the group consisting of SiO2, TiO2, Al2O3, HfO2, SiN, TiN and mixtures thereof.

The protective layer may be deposited using a deposition method selected from the group consisting of e-beam evaporation, sputtering, chemical vapor deposition, atomic layer deposition and thermal evaporation.

The single element phase change optical structure further includes a metal nanoparticle coating layer 400 on an upper surface of the protective layer 300.

The metal is selected from the group consisting of Ag, Au, Pt, Al, Cu, Cr, V, Mg, Ti, Sn, Pb, Pd, W and alloys thereof.

The metal nanoparticle has a diameter of 45 nm to 55 nm.

An active optical element according to another embodiment of the present disclosure includes the single element phase change optical structure.

An active thin film resonator according to another embodiment of the present disclosure includes the single element phase change optical structure.

An active plasmonic nanostructure according to another embodiment of the present disclosure includes the single element phase change optical structure.

### Advantageous Effects

The present disclosure relates to a single element phase change optical structure containing tellurium and a use thereof, and the structure is capable of overcoming a problem of defects of compound-based materials, improving durability, and maximizing light modulation properties as well by replacing an existing compound-based optical phase change material with a tellurium (Te) single element.

Meanwhile, the present disclosure is capable of maximizing an active color modulation effect by simultaneously using properties of thickness change and phase change of the tellurium (Te), and, in addition thereto, has an effect of achieving different optical properties by including various shapes of tellurium nanostructures.

### BRIEF DESCRIPTION OF THE DRAWINGS

FIG. 1 is a schematic diagram of a single element phase change optical structure according to one embodiment of the present disclosure.

FIG. 2 is a schematic diagram of a single element phase change optical structure according to one embodiment of the present disclosure.

FIG. 3 is a schematic diagram of a single element phase change optical structure according to one embodiment of the present disclosure.

FIG. 4 is a schematic diagram of a single element phase change optical structure according to one embodiment of the present disclosure.

FIG. 5 shows a result of analyzing Raman spectral characteristics by thickness of a Te thin film of a single element phase change optical structure according to one embodiment of the present disclosure.

FIG. 6 is a scanning electron microscope (SEM) analysis image identifying a Te thin film of a single element phase change optical structure according to one embodiment of the present disclosure.

FIG. 7 shows a result of analyzing a thickness tendency of a Te thin film of a single element phase change optical structure according to one embodiment of the present disclosure.

FIG. 8 shows a result of identifying a complex refractive index by wavelength of a single element phase change optical structure according to one embodiment of the present disclosure at room temperature (R.T) and 180° C. heated by a ceramic heater through an ellipsometer analysis.

FIG. 9 shows a result of comparative analysis on optical properties of a single element phase change optical structure according to one embodiment of the present disclosure with existing optical phase change materials.

FIG. 10 shows a result of analyzing optical properties depending on variation of a heat treatment temperature of a single element phase change optical structure according to one embodiment of the present disclosure.

FIG. 11 shows a result of identifying a color modulation effect depending on the changes in the thickness of an optical phase change layer 200 of a single element phase change optical structure according to one embodiment of the present disclosure.

FIG. 12 shows a result of identifying changes in the reflectivity depending on the changes in the thickness of a single element phase change optical structure according to one embodiment of the present disclosure.

FIG. 13 shows a result identified by, in order to identify a color modulation effect depending on the changes in the state of an optical phase change layer 200 of a single element phase change optical structure according to one embodiment of the present disclosure, placing the optical structure sample on a hot plate set to a certain temperature and photographing the color change.

FIG. 14 is a scanning electron microscope image identifying shape and size of a Te nanostructure forming an optical phase change layer 200 of a single element phase change optical structure according to one embodiment of the present disclosure.

FIG. 15 shows a result of analyzing optical properties of a single element phase change optical structure according to one embodiment of the present disclosure through a finite-difference time-domain method (FDTD method) using a COMSOL Multiphysics program.

FIG. 16 shows a result of identifying changes in the scattering properties of a single element phase change optical structure according to one embodiment of the present disclosure using a scanning electron microscope.

FIG. 17 shows a result of analyzing scattering properties of a single element phase change optical structure according to one embodiment of the present disclosure through a finite-difference time-domain method (FDTD method) using a Lumerical solutions program.

### BEST MODE

Hereinafter, embodiments of the present disclosure will be described in detail so that those skilled in the art may readily implement the present disclosure. However, the present disclosure may be embodied in various different forms, and is not limited to the embodiments described herein.

Room temperature (R.T.) in the present specification is in a range of 20° C. to 25° C., and more specifically defined as 25° C.

An optical phase change material is one of representative active optical materials, and refers to a material in which changes in the material state are caused by various stimuli such as electrical, thermal and optical stimuli and a complex refractive index changes therethrough. Such an optical phase change material is actively utilized in various optical convergence technologies for a wide wavelength region such as a visible light region and an infrared region.

Existing materials that are well known as such an optical phase change material include GeSbTe (GST), VO2, Sb2S3 and the like. These are compound-based materials, and have characteristics of using a mechanism of state change between amorphous and crystalline states (example: GST) or state change between different crystal phases (example: VO2).

However, although the optical phase change materials known in the art have light modulation properties and are used in various active optical elements, they are vulnerable to defects such as oxygen vacancies occurring during compound formation due to the properties of compound-based materials, and are particularly more vulnerable to defects when formed into a very small structure at a nanometer level, causing a problem of reducing durability. Furthermore, when changing crystal quality (Set) and then restoring it (Reset), external energy such as electricity, temperature (heat) and light under specific conditions different from the set process needs to be requisitely applied, and accordingly, there are disadvantages in that an optimization process for the material phase change is somewhat complicated and addition energy consumption is inevitable.

Accordingly, in order to overcome disadvantages of the compound-based optical phase change materials and further maximize light modulation properties compared to existing materials, the present disclosure is directed to providing a single element phase change optical structure that uses, as a phase change material, tellurium (Te) having various shapes or structures in a single element form, and is capable of substantially modulating optical properties by controlling a state change between a solid phase and a liquid phase by external energy (electricity, heat, pressure and the like).

Accordingly, by using tellurium as a single element phase change material, the optical structure provided in the present disclosure is capable of solving defect problems of existing compound-based materials and improving durability. In addition thereto, the reset process of returning from a liquid phase to a solid phase may be automatically performed under a room temperature and normal pressure condition without additional energy consumption by using the tellurium material, and as a result, there are advantages in that an optimization process for the phase change is relatively simple and external energy consumption is small.

Accordingly, the single element phase change optical structure according to one embodiment of the present disclosure includes a base layer 100; an optical phase change layer 200 formed on an upper surface of the base layer 100; and a protective layer 300 formed on an upper surface of the optical phase change layer 200, wherein the optical phase change layer 200 contains tellurium (Te).

The single element phase change optical structure has excellent light modulation properties due to the phase change of tellurium (Te).

Specifically, the structure of the present disclosure has a maximum refractive index variance (Δnₘₐₓᵢₘᵤₘ) of 1.0 to 1.5 and a maximum extinction coefficient variance (Δkₘₐₓᵢₘᵤₘ) of 1.5 to 2.0 at a wavelength of 700 nm when heated from room temperature (R.T) to 100° C. to change the phase of the Te from solid to liquid.

Preferably, the structure of the present disclosure has a temperature change-dependent refractive index variance rate (dn/dT) of −0.0170 to −0.0160 and a temperature change-dependent extinction coefficient variance rate (dk/dT) of 0.0220 to 0.0230 when heated from room temperature (R.T) to 100° C.

In other words, the optical structure of the present disclosure is characterized in that it is capable of inducing a substantial change in the complex refractive index through the phase change of Te, and may have excellent light modulation properties.

Specifically, the refractive index decreases as the temperature increases, whereas the extinction coefficient increases as the temperature increases, and through this, the present disclosure may achieve a substantial change in the optical properties even at a temperature much lower than 750 K, a melting point of Te.

Meanwhile, the optical phase change layer 200 is deposited on the upper surface of the base layer 100 using a thermal evaporation method.

When tellurium used as the optical phase change layer 200 is deposited on the upper surface of the base layer 100 using a thermal evaporation method, the thickness of the optical phase change layer 200 may be precisely controlled at a nanometer level and the layer may be deposited in the form of a thin film. Through this, a large light modulation effect may be obtained even through a small thickness change at a nanometer level.

Preferably, the optical phase change layer 200 has a deposition temperature (K) range of 150 K to 300 K.

When depositing Te under the deposition temperature range condition, rapid crystallization of tellurium (m.p: 750 K), which has a relatively low melting point compared to other materials, may be prevented through a low-temperature process, and by forming uniform crystals (grains) therethrough, advantages of forming an optical phase change layer 200 having a uniform thickness, and achieving uniform and excellent light modulation properties may be obtained.

However, when the deposition is performed outside the deposition temperature range, Te crystals having various sizes are formed during the deposition process due to rapid crystallization, and there is a disadvantage in that it is difficult to form the optical phase change layer 200 to a uniform thickness.

More preferably, the optical phase change layer 200 has a deposition temperature (K) of 237 K, and by maximizing thickness uniformity under the above-mentioned deposition temperature condition, light modulation properties may also be maximized.

The optical phase change layer 200 has a thickness of 1 nm to 60 nm. More preferably, the thickness may be in a range of 50 nm to 60 nm. However, the thickness of the optical phase change layer 200 is not limited to the above-mentioned range, and is not particularly limited as long as it is in a thickness range that those skilled in the art may adopt to exhibit desired durability and light modulation properties in the structure of the present disclosure.

The base layer 100 is a Si substrate layer or a metal mirror layer.

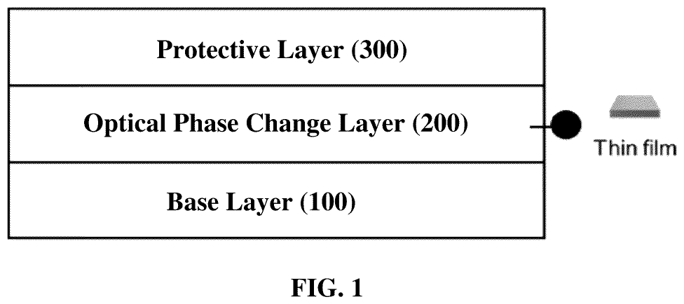

The single element phase change optical structure of the present disclosure is used in an active optical element, an active thin film resonator, an active plasmonic nanostructure or the like, and may provide a structure in which the Si substrate layer, the optical phase change layer 200 and the protective layer 300 are sequentially laminated from the base layer 100 that is a lower surface to the protective layer 300 that is an upper surface. More specifically, a structure in which the optical phase change layer 200 is formed as a Te thin film layer may be provided as one embodiment of the present disclosure (FIG. 1). In this case, properties of changes in the complex refractive index may be obtained due to the phase change of the Te thin film layer, and a structure exhibiting such light modulation properties may be used in an active optical element.

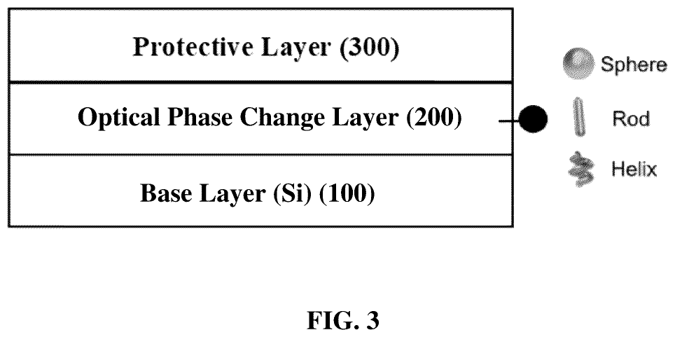

As another embodiment of the present disclosure, a structure including the tellurium of the optical phase change layer 200 in a sphere, rod or helix-shaped nanostructure may be provided. In this case, properties of changes in scattering and circular dichroism (CD) may be obtained due to the phase change of the nanostructure, and such properties may be used in an active plasmonic nanostructure (FIG. 3).

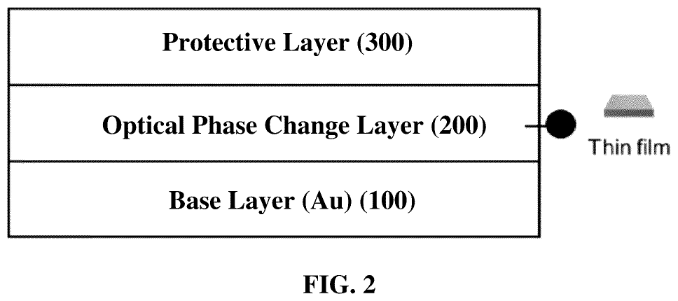

Meanwhile, a structure in which the metal mirror layer, the optical phase change layer 200 and the protective layer 300 are sequentially laminated from the base layer 100 that is a lower surface to the protective layer 300 that is an upper surface may be provided. More specifically, a structure in which the optical phase change layer 200 is formed as a Te thin film layer may be provided as one embodiment of the present disclosure, and in this case, a color modulation effect may be obtained through changes in the thickness of the Te thin film layer, and, in addition thereto, a color modulation effect resulting from the phase change of the Te thin film layer may also be obtained at the same time. Such properties may be used in an active thin film resonator (FIG. 2).

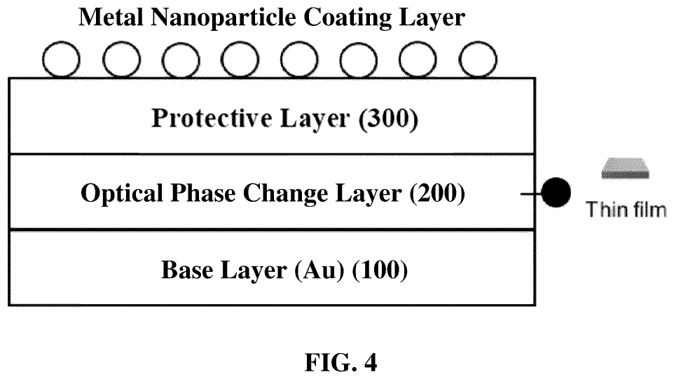

Furthermore, as one embodiment of the present disclosure, a hybrid system of plasmonic nanoparticle-optical phase change thin film may also be provided by additionally coating metal nanoparticles on the upper surface of the protective layer 300 (FIG. 4). In this case, optical property modulation is basically possible by the phase change of the Te thin film layer, and through the optical property modulation resulting from the phase change of Te, changes in the optical properties (scattering properties) of the nanoparticles coated on the upper surface of the protective layer 300 may be additionally induced as well, and as a result, a substantially enhanced light modulation effect may be obtained in overall.

The tellurium (Te) is formed in a structure selected from the group consisting of a thin film, a sphere, a rod, a helix and mixtures thereof.

In other words, the tellurium (Te) included in the optical phase change layer 200 of the present disclosure may be included in the form of a thin film, but may also be formed in the form of a sphere, rod or helix, which is a nanostructure form. When including tellurium in a specific nanostructure form as the optical phase change layer 200 as described above, various optical properties such as scattering, absorption and polarization, which are generally difficult to obtain in the form of a thin film may be obtained depending on the specific shape.

Specifically, a nanostructure has properties of exhibiting special optical properties such as scattering, absorption, polarization and circular dichroism (CD) caused by a complex refractive index of a material itself depending on the shape.

The scattering is an optical phenomenon in which light spreads without specific directivity when entered into a nanostructure, and has properties of expressing colors different from reflection or transmission.

Meanwhile, circular dichroism (CD) is a property of expressing different colors depending on circular polarization, and clockwise polarization is referred to as RCP (right-handed circular polarization) and counterclockwise polarization is referred to as LCP (left-handed circular polarization). It means a property of expressing different colors due to different absorption for each polarization when RCP light and LCP light are given, and is obtained in a special structure having chirality such as a helix-shaped structure.

More specifically, when including the tellurium in a sphere- or rod-shaped nanostructure, scattering properties may be obtained, and when including the tellurium in a helix-shaped nanostructure, circular dichroism (CD) properties may be obtained. The present disclosure has an advantage of utilizing structural properties of the nanostructure and specific optical properties resulting therefrom in various nanophotonics elements.

Meanwhile, each of the nanostructures may be deposited through glancing angle deposition (GLAD). This is a method of controlling a tilting angle (α) and a rotation angle (φ) of a substrate in a physical vapor deposition method such as thermal evaporation to prepare various shapes of nanostructures, and the method is characterized in that nanostructures may be manufactured by a tilting angle and a rotation speed of a substrate optimized for each shape. Using such a GLAD method has an advantage of manufacturing various shapes of nanostructures through changing a deposition condition in a deposition process such as a tilting angle without a complicated lithography process.

The sphere has a radius of 40 nm to 60 nm.

In addition, the rod has a diameter to height ratio (aspect ratio) of 1:3 to 1:6.

In addition, the helix has a minor diameter of 35 nm to 45 nm, and a major diameter of 70 nm to 90 nm.

In addition, the helix has a height of 100 nm to 150 nm.

Specifically, in one embodiment of the present disclosure, the sphere-shaped nanostructure of the tellurium has a radius of 40 nm to 60 nm, and in this case, the wavelength shift value (peak shift) of the scattering peak is in a range of 10 nm to 20 nm when the temperature changes from room temperature (R.T) to 180° C.

Meanwhile, in one embodiment of the present disclosure, the rod-shaped nanostructure of the tellurium has a diameter to height ratio (aspect ratio) of 1:3 to 1:6, and in this case, the wavelength shift value (peak shift) of the scattering peak is in a range of 30 nm to 40 nm when the temperature changes from room temperature (R.T) to 180° C.

Meanwhile, in one embodiment of the present disclosure, the helix-shaped nanostructure of the tellurium has a minor diameter of 35 nm to 45 nm, a major diameter of 70 nm to 90 nm and a height of 100 nm to 150 nm, and in this case, the wavelength shift value (peak shift) of the circular dichroism spectrum is in a range of 15 nm to 20 nm and 35 nm to 45 nm when the temperature changes from room temperature (R.T) to 180° C.

The protective layer 300 is selected from the group consisting of SiO2, TiO2, Al2O3, HfO2, SiN, TiN and mixtures thereof.

In addition, the protective layer may be deposited using a deposition method selected from the group consisting of e-beam evaporation, sputtering, chemical vapor deposition, atomic layer deposition and thermal evaporation.

The protective layer 300 is formed on the upper surface of the optical phase change layer 200 containing Te to maintain the form of the optical phase change layer 200 and prevent damages such as an oxidation reaction. As the protective layer 300, a SiO2 thin film may be deposited to a thickness of 100 nm or greater using a thermal evaporation method, however, those used as a material of the protective layer 300 include TiO2, Al2O3, HfO2, SiN, TiN and the like as well as SiO2, and the material is not particularly limited as long as it is a material capable of maintaining the form of the optical phase change layer 200 and preventing oxidation.

Meanwhile, unlike the optical phase change layer 200, the deposition method of the protective layer 300 is not limited to thermal evaporation, and is defined to include all deposition methods that may be used by those skilled in the art such as e-beam evaporation, sputtering, chemical vapor deposition and atomic layer deposition.

The single element phase change optical structure further includes a metal nanoparticle coating layer 400 on the upper surface of the protective layer 300.

Specifically, the structure of the present disclosure may provide a hybrid system of plasmonic nanoparticle-optical phase change thin film by further including a metal nanoparticle coating layer 400 on the upper surface of the protective layer 300 (FIG. 4), and through this, optical properties of the nanoparticles may be strengthened or modulated.

In other words, when a metal nanoparticle coating layer 400 is included on the upper surface of the protective layer 300 in the structure of the present disclosure, scattering properties of plasmonic nanoparticles (metal nanoparticles) may be substantially modulated through modulating optical properties by the phase change of the Te thin film, and through this, light modulation properties much higher than light modulation properties resulting from a simple state change of the nanostructure may be obtained.

The metal is selected from the group consisting of Ag, Au, Pt, Al, Cu, Cr, V, Mg, Ti, Sn, Pb, Pd, W and alloys thereof, and more preferably, the metal forming the metal mirror layer and the metal nanoparticle is Au, however, the type of the metal forming the metal mirror layer and the metal nanoparticle is not limited to the above-mentioned examples.

Meanwhile, the metal nanoparticle may preferably have a diameter of 45 nm to 55 nm, and herein, the optical phase change layer 200 may have a thickness of 5 nm to 15 nm. In this case, the effect of enhancing light modulation properties aimed in the present disclosure may be further maximized in the ranges of the diameter of the metal nanoparticle and the thickness of the optical phase change layer 200.

An active optical element according to another embodiment of the present disclosure includes the single element phase change optical structure.

The active optical element including the optical structure of the present disclosure is capable of exhibiting excellent light modulation properties using a phase change between solid and liquid of the Te thin film included in the optical structure and changes in the complex refractive index resulting therefrom.

Meanwhile, the active optical element is not limited in the type and the scope as long as it is an element that may be used by those skilled in the art in various optical devices requiring switching of light modulation functions such as optical recording/reproduction systems and display devices.

An active thin film resonator according to another embodiment of the present disclosure includes the single element phase change optical structure.

A thin film resonator is a nanophotonics element capable of expressing various colors with a very small change in a thin film thickness of nanometer level, and specifically, may express various colors through changing reflectivity of a sample by wavelength through coating a thin film having a small thickness of nanometer level on a metal mirror layer. Herein, various colors may be expressed when changing the thickness of the coated thin film.

By using tellurium in the structure of the thin film resonator, the active thin film resonator according to one embodiment of the present disclosure may exhibit an effect of expressing a broader range of colors by additionally using color changes obtained by changes in the phase of tellurium as well as color changes obtained by changes in the thickness of tellurium.

In other words, by changing reflectivity of the structure itself through changing the thickness of the Te thin film included in the optical structure, the active thin film resonator including the optical structure of the present disclosure is capable of exhibiting a color modulation effect to various colors and, in addition thereto, additionally exhibiting a color modulation effect obtained by the phase change of the Te, and as a result, the active color modulation effect may be further maximized by combining the thickness change and the phase change of Te.

An active plasmonic nanostructure according to another embodiment of the present disclosure includes the single element phase change optical structure.

The active plasmonic nanostructure including the optical structure of the present disclosure includes Te included in the optical structure in as a nanostructure having various shapes such as sphere, helix and rod, and is capable of exhibiting additional optical properties of scattering or circular dichroism.

### Manufacture of Single Element Phase Change Optical Structure of Present Disclosure

### Example 1

Using a silicon (Si) substrate purchased as a base layer 100 and a thermal evaporation method, tellurium (Te) was deposited on the substrate in the form of a thin film. After that, as a protective layer 300, a silicon oxide (SiO2) thin film was deposited on an upper surface of the tellurium (Te) thin film to a thickness of 100 nm or greater using a thermal evaporation method. The deposition process of each layer using the thermal evaporation method is as follows.

Specifically, a purchased tellurium (Te) source was placed on a tungsten boat in a deposition chamber, and then the chamber was kept under vacuum at a pressure of 5E-6 (5'10-6) torr or less. After that, voltage was applied to the tungsten boat, and the Te source was vaporized through Joule heating. After that, the vaporized Te atoms were accumulated on a sample (silicon substrate) loaded on an upper sample holder of the chamber to form a Te thin film. Meanwhile, using the same thermal evaporation method, a silicon oxide (SiO2) thin film was formed on an upper surface of the Te thin film as the protective layer 300 (FIG. 1).

Meanwhile, the deposition was performed under a temperature condition of −36° C., a Si wafer having a 2-inch sample size was used, and the deposition rate was maintained at 1 Å/sec so that 0.1 nm was deposited per second. The corresponding deposition condition was used in the same manner in the following Examples 2 to 4.

### Example 2

An optical structure of Example 2 was manufactured in the same manner as in Example 1, except that the silicon (Si) substrate used as the base layer 100 was replaced by a gold (Au) mirror layer (Au mirror) (FIG. 2).

Specifically, Ti was deposited to 15 nm on an upper surface of the Si substrate using an E-beam evaporation method, and then Au was deposited to 150 nm on an upper surface thereof as the base layer 100 of the present disclosure. The reason for depositing Ti on an upper surface of the Si substrate before Au as above is to improve deposition efficiency by using Ti as an adhesion layer since Au may be readily peeled off when deposited directly on Si.

Meanwhile, a Te thin film was formed on an upper surface of the Au layer using the same deposition method as in Example 1, and then a silicon oxide (SiO2) thin film was formed on an upper surface of the Te thin film as the protective layer 300. Process conditions such as deposition temperature, sample size and deposition rate were the same as in Example 1.

### Example 3

In the structure of the optical structure of Example 1, tellurium (Te) forming the optical phase change layer 200 was deposited in a sphere-shaped nanostructure form instead of the thin film form, and an alumina (Al2O3) thin film was deposited on an upper surface thereof as the protective layer 300 to manufacture an optical structure (FIG. 3).

For the deposition of the optical phase change layer 200, a glancing angle deposition (GLAD) method capable of manufacturing various shapes of nanostructures by controlling a tilting angle (α) and a rotation angle (φ) of the substrate was used among thermal evaporation methods.

Specifically, unlike the deposition process performed while maintaining a tilting angle of the Si substrate, which was used as the base layer 100 in Example 1, at 0° to deposit tellurium (Te) in the form of a thin film, a sphere-shaped tellurium (Te) nanostructure was deposited on a Si substrate used as the base layer 100 by controlling a tilting angle and a rotation angle of the substrate. Meanwhile, in order to uniformly cover a protruding structure such as a nanostructure, an alumina (Al2O3) thin film, which is the protective layer 300, was formed on an upper surface of the sphere-shaped tellurium (Te) nanostructure using an atomic layer deposition method.

### Example 4

An optical structure was manufactured in the same manner as in Example 3, except that a rod-shaped tellurium (Te) nanostructure was laminated on a Si substrate used as the base layer 100 by controlling a tilting angle and a rotation angle of the substrate (FIG. 3).

### Example 5

An optical structure was manufactured in the same manner as in Example 3, except that a helix-shaped tellurium (Te) nanostructure was laminated on a Si substrate used as the base layer 100 by controlling a tilting angle and a rotation angle of the substrate (FIG. 3).

### Example 6

An optical structure was manufactured by further coating Au nanoparticles on the upper surface of the silicon oxide (SiO2) thin film of the optical structure manufactured in Example 2 for 1 minute using a coating method utilizing electrostatic force (FIG. 4).

### Identification of Thin Film Structure and Optical Properties of Tellurium (Te)

Whether the tellurium (Te) was normally formed in the form of a thin film was identified for the optical structure of Example 1 through analyzing Raman spectroscopy characteristics using a Raman spectrometer, and whether the thickness of the tellurium (Te) thin film was able to be controlled was identified through a scanning electron microscope (SEM) analysis.

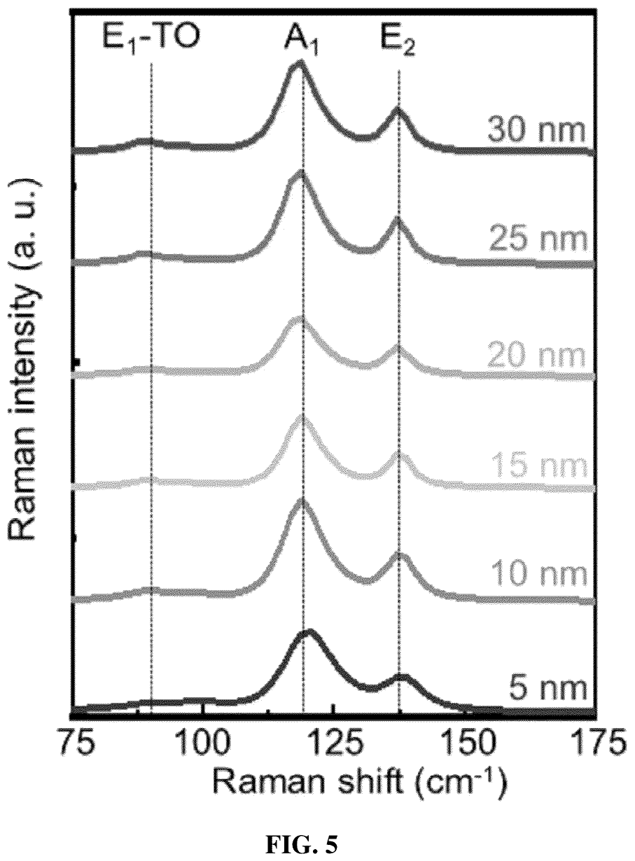

Specifically, referring to FIG. 5, which is the result of analyzing Raman spectroscopy characteristics by thickness (5, 10, 15, 20, 25, 30 nm) of the Te thin film in order to identify whether other impurities were included in the Te thin film or unusual crystal structures were revealed under the deposition condition of the present disclosure, it may be identified that the Te thin film is favorably formed in the thermal evaporation method under the deposition condition of the present disclosure.

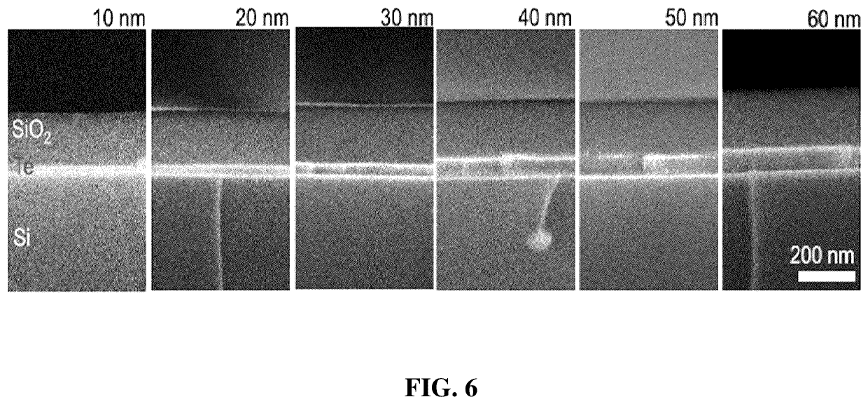

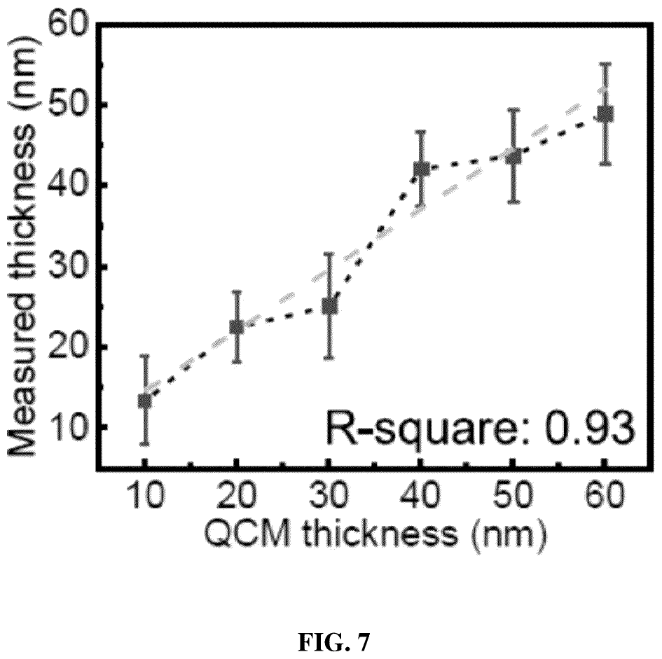

Meanwhile, a scanning electron microscope (SEM) analysis was performed in order to identify whether the Te thin film thickness (QCM thickness) set in the deposition apparatus and the thin film thickness actually deposited are matched well. Referring to the SEM images identifying whether the thickness of the Te thin film was controlled under the deposition condition of the present disclosure and the results analyzing a thickness tendency of the Te thin film based thereon (FIGS. 6 and 7), it may be identified that the thickness of the Te thin film may be precisely controlled at a nanometer level for deposition in the thermal evaporation method under the process condition of the present disclosure.

### Identification of Optical Properties (1)

Optical properties of the optical structure of Example 1 were identified through changes in the complex refractive index (refractive index (n), extinction coefficient (k)).

First, changes in the optical properties depending on changes in the states between solid and liquid phases of Te were identified through an in-situ heating spectroscopic ellipsometry analysis. Specifically, a separately purchased ceramic heater (MC2550) was connected to an amplifier capable of supplying AC voltage to ellipsometer equipment, and by heating the Te thin film using the same, a complex refractive index by wavelength depending on the changes in the Te state was measured.

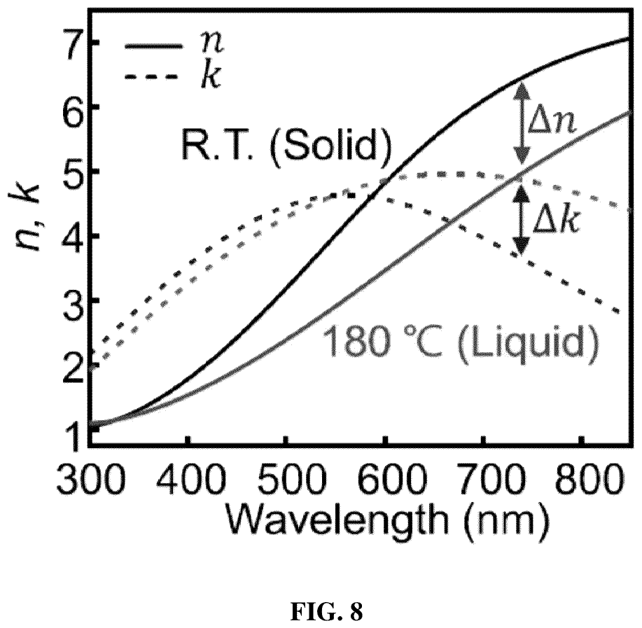

Specifically, for the optical structure including the Te thin film having a thickness of 60 nm, a complex refractive index by wavelength at room temperature (R.T) and 180° C. heated by the ceramic heater was identified through an ellipsometer analysis, and the results are shown in FIG. 8.

Referring to FIG. 8, it may be identified that the refractive index (n) and the extinction coefficient (k) reversibly and significantly change in a visible light region depending on the changes in the state of Te. Particularly, it was identified that the refractive index n changed by the maximum of 1.53 (Δnₘₐₓᵢₘᵤₘ) and the extinction coefficient k changed by the maximum of 0.97 (Δkₘₐₓᵢₘᵤₘ) at a wavelength of 700 nm.

Through this, it may be identified that substantial changes in the optical properties (changes in complex refractive index) may be obtained at a much lower temperature (180° C.) than 450° C., a melting point of Te.

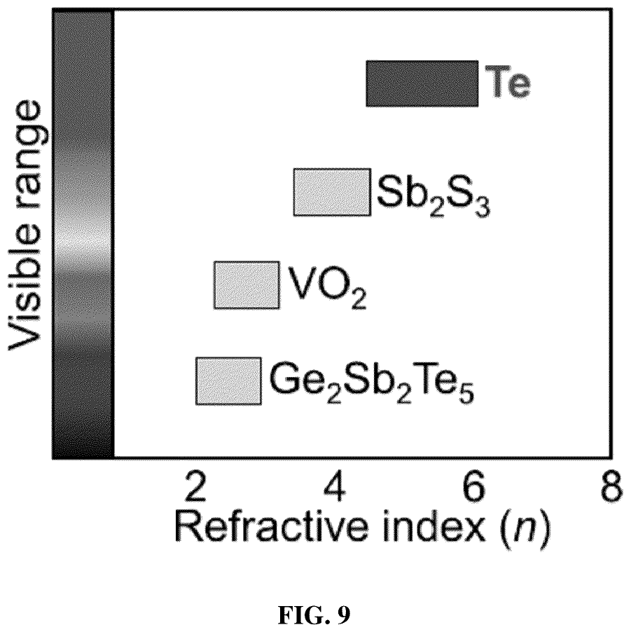

Meanwhile, refractive index (n) variances of existing optical phase change materials (GeSbTe, VO2, Sb2S3) and the optical structure of Example 1 of the present disclosure in a visible light region were compared using the ellipsometer analysis, and the results are shown in FIG. 9.

Referring to FIG. 9, it may be identified that the structure of the present disclosure including the Te thin film that is a single element in the optical phase change layer 200 has more superior light modulation properties (changes in complex refractive index) in a visible light region compared to other optical phase change materials formed with compounds.

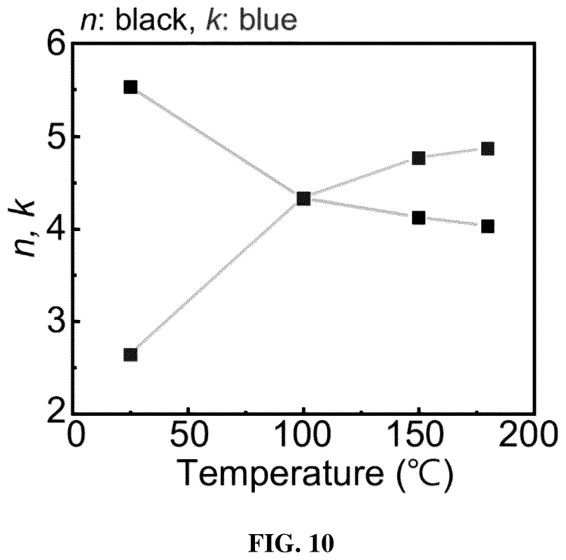

Furthermore, for the optical structure of Example 1, optical properties depending on the heat treatment temperature variation were identified. Specifically, the complex refractive index (n, k) by wavelength of the Te thin film obtained by varying the heat treatment temperature to 100° C., 150° C. and 180° C. was measured through the ellipsometer analysis, and the results are shown in FIG. 10.

Referring to FIG. 10, when the Te thin film was heated from room temperature (R.T) to 100° C., it was identified that the change in the refractive index n was about 1.1, and the change in the extinction coefficient k was about 1.7 at a wavelength of 700 nm, showing significant changes.

Meanwhile, when heated from room temperature (R.T) to 100° C., the refractive index variance rate (dn/dT) depending on the temperature change and the extinction coefficient variance rate (dk/dT) depending on the temperature change were −0.0161 and 0.0226, respectively, and it was identified that the refractive index decreased as the temperature increased, whereas the extinction coefficient increased as the temperature increased.

In other words, it may be identified that the temperature change-dependent refractive index variance rate (dn/dT) of the Te thin film was about 100 times larger than that of water (0.0001) having a boiling point of 100° C., and through this, it may be seen that the optical structure of the present disclosure may exhibit substantial light modulation properties by slight changes in the temperature.

### Identification of Color Modulation Effect

For the optical structure of Example 2, color modulation effects obtained from the thickness change and the state change of the optical phase change layer 200 were each identified.

First, in order to identify the color modulation effect depending on the change in the thickness of the optical phase change layer 200, it was identified whether thin film resonator properties were exhibited by introducing the Te thin film, and for the optical structure of Example 2, changes in the color of the thin film resonator obtained by varying the thickness of the Te thin film layer were identified.

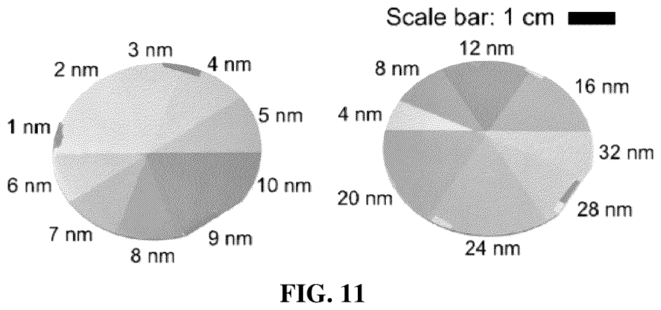

Referring to FIG. 11, which shows a photographic image of each sample with different thickness, it was identified that, as the thickness of the Te thin film layer changed, the sample of each optical structure showed a clear color change distinguishable with the naked eye such as from yellow to brown, purple, dark blue and the like.

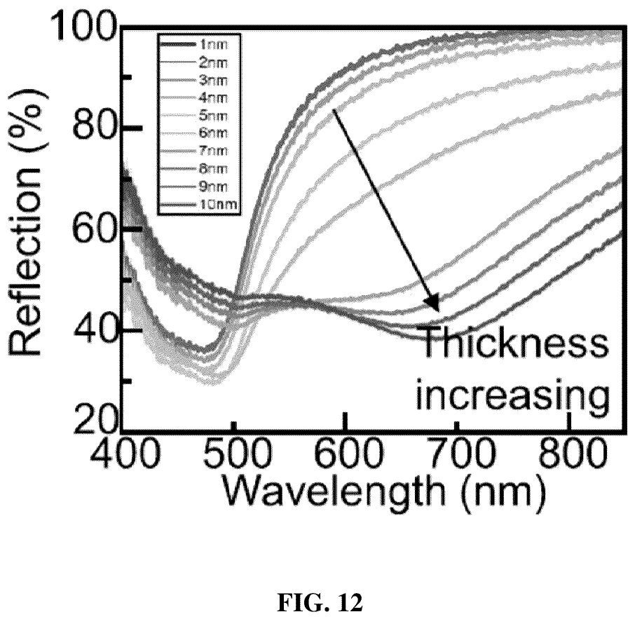

Meanwhile, as a result of measuring reflectivity while varying the thickness of the Te thin film from 1 nm to 10 nm in 1 nm intervals through a spectrometer, it was identified that significant changes in the reflectivity were obtained even with a thickness difference of 1 nm (FIG. 12).

Through the above-described experiment, it may be identified that a thin film resonance phenomenon occurs in the optical structure of the present disclosure even at a thickness of 10 nm or less, and a substantial color modulation effect may be identified even with a slight thickness change of 1 nm, and accordingly, it was identified that the optical structure of the present disclosure was able to be used in a thin film resonator expressing selective colors depending on the change in the thickness of Te.

Furthermore, in order to identify the color modulation effect obtained by changing the state of the optical phase change layer 200, the optical structure sample was placed on a hot plate set to a certain temperature, and the effect was identified by photographing color changes.

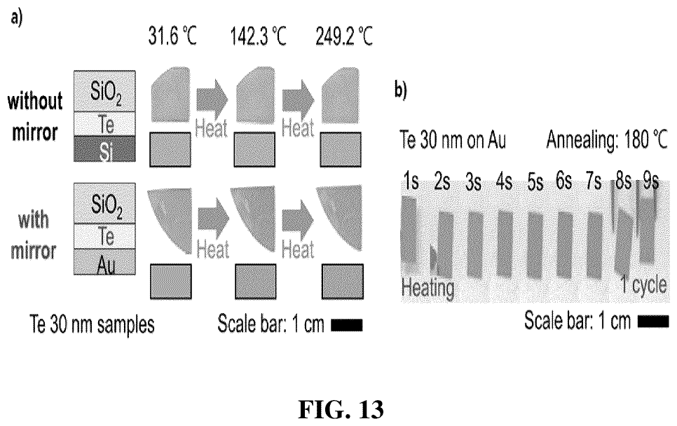

Referring to FIG. 13, it may be identified that, when the metal mirror layer (Au mirror) is introduced in the thin film having a Te thickness of 30 nm, clear color changes are obtained at the same heat treatment temperature compared to a case where it is not introduced, and it was identified that the structure of the present disclosure including a thin film having a Te thickness of 30 nm on the metal mirror layer (Au mirror) had rapid color changes within 10 seconds at a temperature of 180° C.

In other words, by the structure of the present disclosure including a metal mirror layer on a lower surface of the Te thin film layer, a thin film resonance phenomenon may occur by causing color modulation even at a small thickness of 10 nm or less through the change in the thickness of the Te thin film layer, and an active color modulation effect may be obtained as well through the change in the state of the Te thin film layer, and as a result, it was identified that the structure of the present disclosure was able to be used in an active thin film resonator.

### Identification of Optical Properties (2)

Optical properties of each of the optical structures of Examples 3 to 5 were identified through changes in the scattering, absorption, polarization and circular dichroism (CD).

First, whether the shape of the Te nanostructure forming the optical phase change layer 200 of each of the optical structures of Examples 3 to 5 was formed well, and the size of the manufactured structure were identified through a scanning electron microscope.

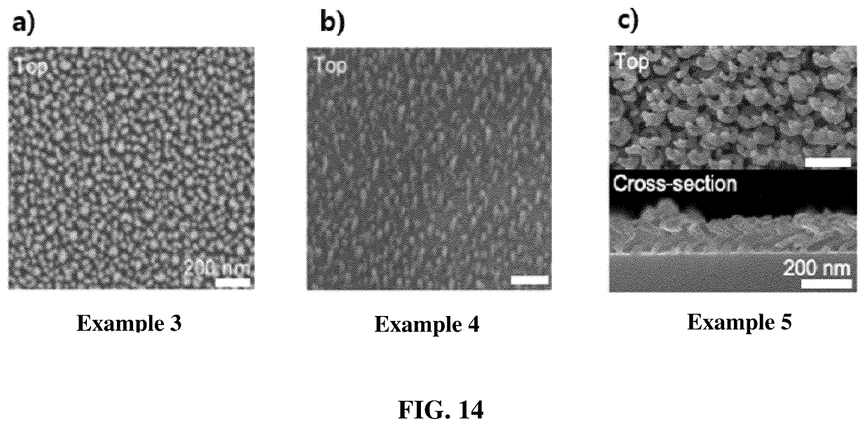

Referring to FIG. 14, it may be identified that the Te nanostructures of the optical structures of Examples 3 to 5 were formed in sphere-, rod- and helix-shapes, respectively. Specifically, it was identified that the sphere-shaped structure forming the Te nanostructure had a radius of 50 nm in Example 3, and the rod-shaped structure forming the Te nanostructure of Example 4 had a diameter to height ratio (aspect ratio) of 1:5. Meanwhile, it was identified that the helix-shaped structure forming the Te nanostructure of Example 5 had a minor diameter of 40 nm, a major diameter of 80 nm and a height of 130 nm, and had a left-handed helix, 2-turn structure.

In addition, optical properties of each of the optical structures of Examples 3 to 5 were analyzed through a finite-difference time-domain method (FDTD method) using a COMSOL Multiphysics program.

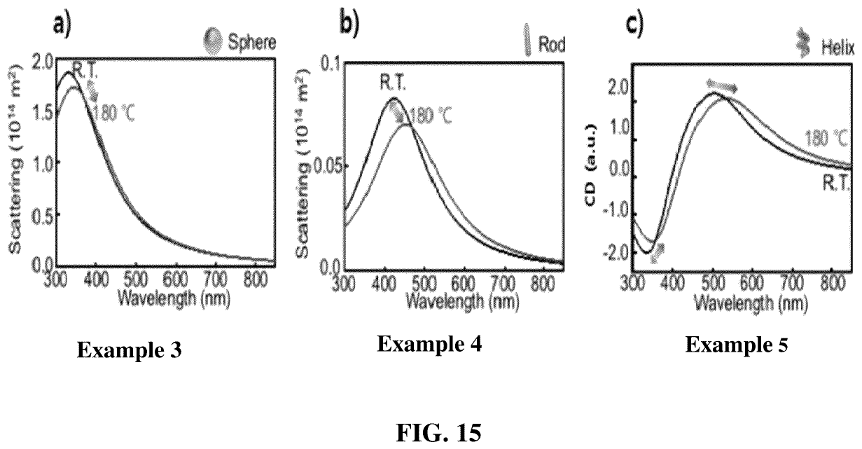

Referring to FIG. 15, it was identified that the scattering peak wavelength in the structure of Example 3 had a peak shift of about 15 nm from 331 nm (R.T.) to 345 nm (180° C.), and it may be identified that changes in the scattering intensity occurs in a UV region close to a visible light wavelength region.

Meanwhile, for the structure of Example 4, a simulation was performed by aligning the polarization direction of light with the long axis of the rod-shaped nanostructure, and as a result, it was identified that the scattering peak wavelength had a peak shift of about 35 nm from 420 nm (R.T.) to 455 nm (180° C.). Meanwhile, it was identified that a slight peak shift and changes in the scattering intensity occurred in the blue color in the visible light wavelength region.

In addition, in the structure of Example 5, it was identified that, among the two peaks in the circular dichroism spectrum, the peak wavelength of the relatively short wavelength had a peak shift of about 18 nm from 335 nm (R.T.) to 353 nm (180° C.), and the peak wavelength of the long wavelength had a peak shift of about 40 nm from 502 nm (R.T.) to 542 nm (180° C.). Meanwhile, it was identified that a peak shift occurred in the green color in the visible light wavelength region.

In summary, it may be identified that sphere-, rod- and helix-shaped Te nanostructures are included in the optical phase change layers 200 of Examples 3 to 5, respectively, and scattering or circular dichroism properties may be obtained by the phase change of Te. Specifically, it may be identified that “scattering” properties change by the phase change of Te when sphere- and rod-shaped Te nanostructures are included, and optical properties for “circular dichroism” change by the phase change of Te when a helix-shaped Te nanostructure is included.

In other words, when including the Te single element included in the optical phase change layer 200 of the present disclosure as a nanostructure having various specific shapes, the optical structure of the present disclosure may be used in an active plasmonic nanostructure.

In addition, optical properties for the optical structure of Example 6 were identified through changes in the scattering properties.

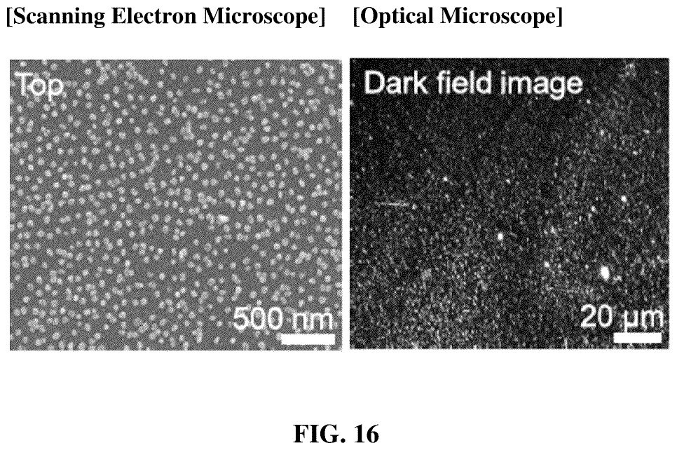

First, through the scanning electron microscope image of the optical structure of Example 6, it may be identified that Au nanoparticles are uniformly coated on the upper surface of the protective layer 300, and through the optical microscope dark field image capable of analyzing scattered light, it may be visibly identified that the optical structure of Example 6 exhibits strong scattering (FIG. 16).

Meanwhile, for the optical structure of Example 6, scattering properties were analyzed through a finite-difference time-domain method (FDTD method) using a Lumerical solutions program.

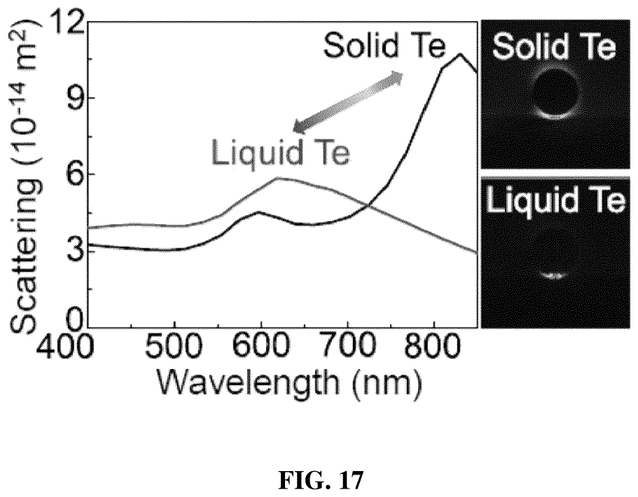

Referring to FIG. 17, it was identified that a large scattering peak shift of 210 nm was observed by the changes in the solid phase (peak wavelength: 830 nm) and the liquid phase (peak wavelength: 619 nm) of Te. In other words, it may be identified that wideband light modulation properties capable of utilization/modulation in not only a visible light region but also a near-infrared (NIR) region are obtained.

In addition, referring to the right part of FIG. 17, when electric field spatial distribution in the Te thin film was checked at the peak wavelength of incident light, clear changes in the electric field distribution may be identified in the solid phase and the liquid phase.

In summary, in the optical structure of Example 6, optical property modulation is basically possible by the phase change of the Te thin film layer, and through the optical property modulation resulting from the phase change of Te, changes in the optical properties (scattering properties) of the nanoparticles coated on the upper surface of the protective layer 300 may be additionally induced as well, and as a result, a substantially enhanced light modulation effect may be obtained in overall.

Hereinbefore, preferred embodiments of the present disclosure have been described in detail, however, the scope of a right of the present disclosure is not limited thereto, and various modified and improved forms made by those skilled in the art using the basic concept of the present disclosure defined in the claims also fall within the scope of a right of the present disclosure.

### REFERENCE NUMERAL

100: Base Layer
200: Optical Phase Change Layer
300: Protective Layer
400: Metal Nanoparticle Coating Layer

What is claimed is:

1. A single element phase change optical structure comprising:
a base layer;
an optical phase change layer formed on an upper surface of the base layer; and
a protective layer formed on an upper surface of the optical phase change layer,
wherein the optical phase change layer contains tellurium (Te).

2. The structure of claim 1, which has excellent light modulation properties due to a phase change of the tellurium (Te).

3. The structure of claim 1, which has a maximum refractive index variance (Δnₘₐₓᵢₘᵤₘ) of 1.0 to 1.5 at a wavelength of 700 nm when heated from room temperature (R.T) to 100° C.

4. The structure of claim 1, which has a maximum extinction coefficient variance (Δkₘₐₓᵢₘᵤₘ) of 1.5 to 2.0 at a wavelength of 700 nm when heated from room temperature (R.T) to 100° C.

5. The structure of claim 1, wherein the optical phase change layer is deposited on the upper surface of the base layer using a thermal evaporation method.

6. The structure of claim 5, wherein the optical phase change layer has a deposition temperature (K) range of 150 K to 300 K.

7. The structure of claim 1, wherein the optical phase change layer has a thickness of 1 nm to 60 nm.

8. The structure of claim 1, wherein the base layer is a Si substrate layer or a metal mirror layer.

9. The structure of claim 1, wherein the tellurium (Te) is formed in a structure selected from the group consisting of a thin film, a sphere, a rod, a helix and mixtures thereof.

10. The structure of claim 9, wherein the sphere has a radius of 40 nm to 60 nm.

11. The structure of claim 9, wherein the rod has a diameter to height ratio (aspect ratio) of 1:3 to 1:6.

12. The structure of claim 9, wherein the helix has a minor diameter of 35 nm to 45 nm, and a major diameter of 70 nm to 90 nm.

13. The structure of claim 9, wherein the helix has a height of 100 nm to 150 nm.

14. The structure of claim 1, wherein the protective layer is selected from the group consisting of SiO2, TiO2, Al2O3, HfO2, SiN, TiN and mixtures thereof.

15. The structure of claim 14, wherein the protective layer is deposited using a deposition method selected from the group consisting of e-beam evaporation, sputtering, chemical vapor deposition, atomic layer deposition and thermal evaporation.

16. The structure of claim 1, further comprising a metal nanoparticle coating layer on an upper surface of the protective layer.

17. The structure of claim 8, wherein the metal is selected from the group consisting of Ag, Au, Pt, Al, Cu, Cr, V, Mg, Ti, Sn, Pb, Pd, W and alloys thereof.

18. The structure of claim 14, wherein the metal nanoparticle has a diameter of 45 nm to 55 nm.

19. An active optical element comprising the structure of claim 1.

20. An active plasmonic nanostructure comprising the structure of claim 1.
